(19) United States
(12) Patent Application Publication
(10) Pub. No.: US 2023/0005448 A1
(43) Pub. Date: Jan. 5, 2023

(54) DISPLAY CONTROL APPARATUS, CONTROL METHOD, AND NON-TRANSITORY COMPUTER-READABLE STORAGE MEDIUM

(71) Applicant: NEC Corporation, Minato-ku, Tokyo (JP)

(72) Inventor: Shintaro YAMADA, Tokyo (JP)

(73) Assignee: NEC Corporation, Minato-ku, Tokyo (JP)

(21) Appl. No.: 17/781,092

(22) PCT Filed: Dec. 4, 2020
(86) PCT No.: PCT/JP2020/045206

§ 371 Date: May 31, 2022

(30) Foreign Application Priority Data
Dec. 11, 2019 (JP) 2019-223559

(51) Int. Cl. G09G 5/00; G06Q 30/06; G06Q 30/02

(52) U.S. Cl. CPC G09G 5/006; G06Q 30/0643; G06Q 30/0241; G09G 2380/04

(57) ABSTRACT

A display control apparatus (2000) is configured to: acquire a target image (10) including a display apparatus (30) provided at an exhibition place (40) and a product (20) exhibited in the exhibition place (40); to recognize the product (20) included in the target image (10), and acquire relevant information (54) of the product (20); determine, based on a relative positional relationship within the target image (10) between the product (20) and the display apparatus (30), a display position at which a display (32) representing the relevant information (54) of the product (20) is displayed in the display apparatus (30); and display the display (32) of the product (20) at the determined display position on the display apparatus (30).

### TECHNICAL FIELD

The present invention relates to control of a display apparatus that displays information relating to a product.

### BACKGROUND ART

A shelf label indicating a price of a product or the like is provided at an exhibition place of a product, such as an exhibition shelf Then, a technique utilizing, instead of a paper medium, an electronic medium (an electronic shelf label or the like) as such a shelf label has been developed.

Patent Document 1 discloses an electronic shelf label system that displays, on an electronic shelf label in which a longitudinal direction of a display screen is provided along a horizontal direction of an exhibition shelf, information relating to a product provided on the exhibition shelf In Patent Document 1, a clerk or the like manually inputs a layout of a product on an exhibition shelf, and a simulation of exhibition is performed according to the input. Then, according to a result of the simulation, a layout of display of information is determined for each of a plurality of kinds of products to be exhibited on the exhibition shelf

### RELATED DOCUMENTS

Patent Documents

[Patent Document 1] Japanese Patent Application Publication No. 2014-193218

[Patent Document 2] International Patent Publication No. WO 2016/052382

### SUMMARY OF THE INVENTION

### Technical Problem

In an electronic shelf label system of Patent Document 1, a clerk or the like needs to manually input a layout of a product. Thus, labor of a clerk or the like is great.

The present invention has been made in view of the above-described problem, and one object thereof is to provide a technique for reducing labor required for displaying information relating to a product on a display apparatus.

### Solution to Problem

A display control apparatus according to the present invention includes 1) a first acquisition unit that acquires a target image. The target image includes a display apparatus provided at an exhibition place of a product, and a product exhibited at the exhibition place.

The display control apparatus further includes 2) a second acquisition unit that recognizes a product included in the target image, and acquires relevant information being information relevant to the product, 3) a display position determination unit that determines, based on a relative positional relationship within the target image between the product and the display apparatus, a display position at which a relevant display representing relevant information of the product is displayed in the display apparatus, and 4) a display control unit that displays the relevant display of the product at the display position on the display apparatus.

A control method according to the present invention is executed by a computer. The control method includes a first acquisition step of acquiring a target image. The target image includes a display apparatus provided at an exhibition place of a product, and a product exhibited at the exhibition place. The control method further includes 2) a second acquisition step of recognizing a product included in the target image, and acquiring relevant information being information relevant to the product, 3) a display position determination step of determining, based on a relative positional relationship within the target image between the product and the display apparatus, a display position at which a relevant display representing relevant information of the product is displayed in the display apparatus, and 4) a display control step of displaying the relevant display of the product at the display position on the display apparatus.

A program according to the present invention causes a computer to execute the control method according to the present invention.

### ADVANTAGEOUS EFFECTS OF INVENTION

The present invention provides a technique for reducing labor required for displaying information relating to a product on a display apparatus.

### BRIEF DESCRIPTION OF THE DRAWINGS

FIG. 1 is a diagram conceptually illustrating an operation of a display control apparatus according to an example embodiment 1.

FIG. 2 is a block diagram illustrating a functional configuration of the display control apparatus.

FIG. 3 is a diagram illustrating a computer for achieving the display control apparatus.

FIG. 4 is a flowchart illustrating a flow of processing executed by the display control apparatus according to the example embodiment 1.

FIG. 5 is a diagram illustrating a utilization environment of the display control apparatus.

FIG. 6 is a diagram illustrating a scene in which a bar type display is utilized.

FIG. 7 is a first diagram illustrating a relative positional relationship on a target image between display and a product.

FIG. 8 is a second diagram illustrating a relative positional relationship on a target image between display and a product.

FIG. 9 is a diagram illustrating a case where the number of faces of a product is equal to or more than two.

FIG. 10 is a diagram illustrating a case where display of a product is displayed on a display apparatus provided on a shelf board on which the product is exhibited.

FIG. 11 is a diagram illustrating a case where a plurality of display apparatuses are provided on one shelf board.

FIG. 12 is a diagram illustrating a case where a plurality of display apparatuses being long in a vertical direction are provided at positions differing from each other in a horizontal direction.

FIG. 13 is a diagram illustrating a case where a plurality of display apparatuses are provided on one side wall.

FIG. 14 is a diagram illustrating a case where a size of a display apparatus is determined according to an exhibition status of a product.

### DESCRIPTION OF EMBODIMENTS

Hereinafter, an example embodiment of the present invention is described by use of the drawings. Note that, a similar reference sign is assigned to a similar component in all the drawings, and description is omitted accordingly. Moreover, unless otherwise specially described, each block represents, in each block diagram, not a configuration on a hardware basis but a configuration on a function basis. In the following description, unless otherwise specially described, various predetermined values (threshold values and the like) are stored in advance in a storage apparatus being accessible from a functional configuration unit utilizing the values.

### Example Embodiment 1

<Outline>

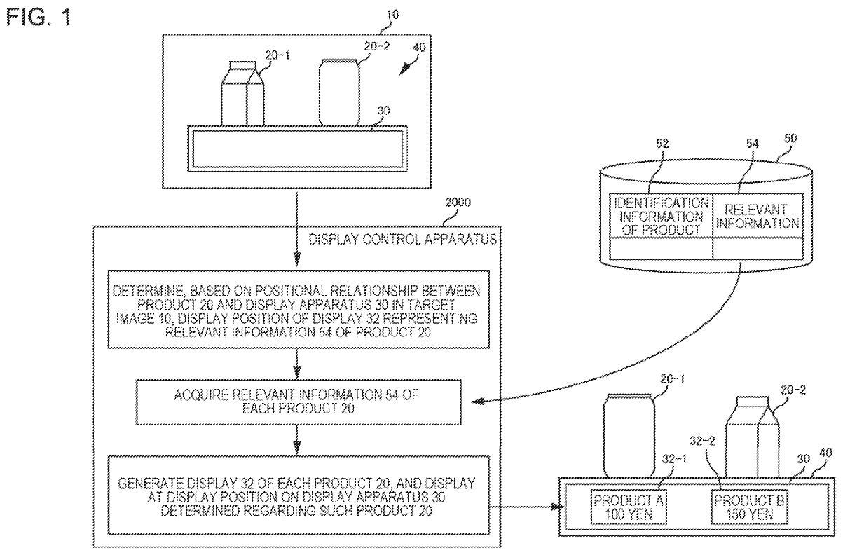

FIG. 1 is a diagram conceptually illustrating an operation of a display control apparatus 2000 according to an example embodiment 1. Herein, the operation of the display control apparatus 2000 described by use of FIG. 1 is an exemplification for easing understanding of the display control apparatus 2000, and does not limit the operation of the display control apparatus 2000. Details and a variation of the operation of the display control apparatus 2000 are described later.

The display control apparatus 2000 displays information relating to a product 20 exhibited at an exhibition place 40 on a display apparatus 30 provided at the exhibition place 40. The information relating to the product 20 is, for example, a name or a price of the product 20, or an advertisement or the like of the product 20. Hereinafter, the operation of the display control apparatus 2000 is more specifically described.

The display control apparatus 2000 acquires a target image 10. The target image 10 is generated by a camera that has captured the exhibition place 40. The target image 10 includes the product 20 exhibited on the exhibition place 40, and the display apparatus 30 provided at the exhibition place 40.

The display control apparatus 2000 performs an image analysis regarding the target image 10, and thereby recognizes each of the products 20 included in the target image 10. Further, regarding each of the products 20, the display control apparatus 2000 acquires relevant information 54 of the product 20 from a relevant information storage apparatus 50. The relevant information storage apparatus 50 stores identification information 52 of the product 20 and the relevant information 54 in association with each other. The identification information 52 is any information with which the product 20 is identifiable. For example, a Japan article number (JAN) code can be utilized as the identification information 52. The relevant information 54 indicates information relating to the product 20 that should be displayed on the display apparatus 30.

The display control apparatus 2000 performs an image analysis regarding the target image 10, and thereby determines a position on the display apparatus 30 on which the relevant information 54 of the product 20 should be displayed. A display position at which the relevant information 54 of the product 20 should be displayed is determined based on a relative positional relationship within the target image 10 between the product 20 and the display apparatus 30.

The display control apparatus 2000 generates, by use of the relevant information 54 of the product 20, a display 32 representing a content thereof For example, the display 32 is an image representing a content of the relevant information 54 of the product 20. Then, the display control apparatus 2000 displays the display 32 of the product 20 at the display position on the display apparatus 30 determined regarding the product 20.

For example, in an example in FIG. 1, the target image 10 includes a product 20-1 and a product 20-2. The display control apparatus 2000 performs an image analysis of the target image 10, and thereby recognizes the product 20-1 and the product 20-2. The display control apparatus 2000 acquires relevant information 54 regarding each of the products 20-1 and 20-2.

The display control apparatus 2000 determines, based on a positional relationship within the target image 10 between the product 20-1 and the display apparatus 30, a display position at which the relevant information 54 of the product 20-1 should be displayed. Similarly, the display control apparatus 2000 determines, based on a positional relationship within the target image 10 between the product 20-2 and the display apparatus 30, a display position at which the relevant information 54 of the product 20-2 should be displayed.

The display control apparatus 2000 generates a display 32-1 representing the relevant information 54 of the product 20-1, and displays the display 32-1 at the display position determined regarding the product 20-1. Similarly, the display control apparatus 2000 generates a display 32-2 representing the relevant information 54 of the product 20-2, and displays the display 32-2 at the display position determined regarding the product 20-2.

<Representative Advantageous Effect>

The display control apparatus 2000 according to the present example embodiment performs an image analysis on a target image 10 including a product 20 and a display apparatus 30, and as a result, acquisition of information (relevant information 54) relating to the product 20, determination of a position on the display apparatus 30 at which a display 32 representing the relevant information 54 should be displayed, and display of the display 32 at the position are performed. Thus, a user (a clerk or the like) of the display control apparatus 2000 does not need to manually input a layout of the product 20 at an exhibition place 40. Therefore, compared with an invention of Patent Document 1, there is an advantage that labor required for displaying information relating to a product on a display is small.

Hereinafter, the display control apparatus 2000 is described in more detail.

### Example of Functional Configuration

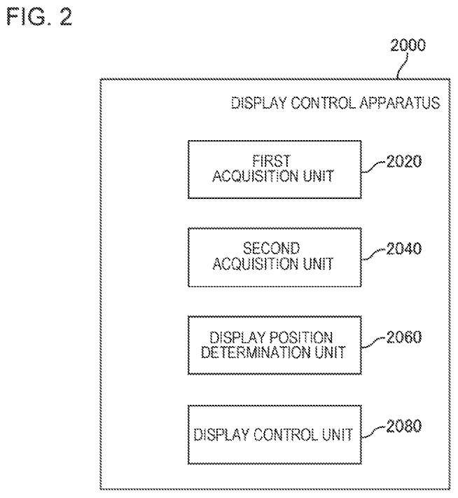

FIG. 2 is a block diagram illustrating a functional configuration of the display control apparatus 2000. The display control apparatus 2000 includes a first acquisition unit 2020, a second acquisition unit 2040, a display position determination unit 2060, and a display control unit 2080. The first acquisition unit 2020 acquires a target image 10. The second acquisition unit 2040 performs image processing on the target image 10, and thereby recognizes a product 20 included in the target image 10. Further, the second acquisition unit 2040 acquires relevant information 54 regarding the recognized product 20. The display position determination unit 2060 determines, based on a relative positional relationship in the target image 10 between the product 20 and a display apparatus 30, a display position on the display apparatus 30 at which the relevant information 54 of the product 20 should be displayed. The display control unit 2080 displays the display 32 representing the relevant information 54 of the product 20 at the determined display position on the display apparatus 30.

### Example of Hardware Configuration of Display Control Apparatus 2000

Each functional configuration unit of the display control apparatus 2000 may be achieved by hardware (example: a hard-wired electronic circuit, or the like) that achieves each functional configuration unit, or may be achieved by a combination of hardware and software (example: a combination of an electronic circuit and a program controlling the electronic circuit, or the like). A case where each functional configuration unit of the display control apparatus 2000 is achieved by a combination of hardware and software is further described below.

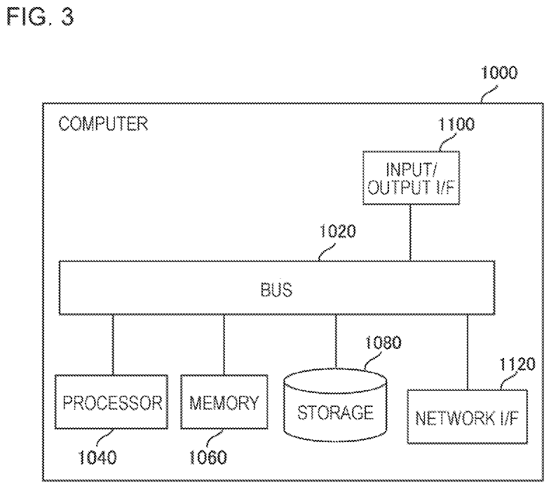

FIG. 3 is a diagram illustrating a computer 1000 for achieving the display control apparatus 2000. The computer 1000 is any computer. For example, the computer 1000 is a stationary computer such as a personal computer (PC) or a server machine. Additionally, for example, the computer 1000 is a portable computer such as a smartphone or a tablet terminal.

The computer 1000 may be a dedicated computer designed to achieve the display control apparatus 2000, or may be a general-purpose computer. In the latter case, each function of the display control apparatus 2000 is achieved in the computer 1000, for example, by installing a predetermined application in the computer 1000. The above-described application is configured by a program for achieving a functional configuration unit of the display control apparatus 2000.

The computer 1000 includes a bus 1020, a processor 1040, a memory 1060, a storage device 1080, an input/output interface 1100, and a network interface 1120. The bus 1020 is a data transmission path through which the processor 1040, the memory 1060, the storage device 1080, the input/output interface 1100, and the network interface 1120 transmit/receive data to/from one another. However, a method of mutually connecting the processor 1040 and the like is not limited to bus connection.

The processor 1040 is various processors such as a central processing unit (CPU), a graphics processing unit (GPU), and a field-programmable gate array (FPGA). The memory 1060 is a main storage apparatus achieved by use of a random access memory (RAM) or the like. The storage device 1080 is an auxiliary storage apparatus achieved by use of a hard disk, a solid state drive (SSD), a memory card, a read only memory (ROM), or the like.

The input/output interface 1100 is an interface for connecting the computer 1000 and an input/output device with each other. For example, an input apparatus such as a keyboard and an output apparatus such as a display apparatus are connected to the input/output interface 1100.

The network interface 1120 is an interface for connecting the computer 1000 to a communication network. The communication network is, for example, a local area network (LAN) or a wide area network (WAN).

The storage device 1080 stores a program that achieves each functional configuration unit of the display control apparatus 2000 (a program module that achieves the above-described application). The processor 1040 reads each of the programs onto the memory 1060, executes the read program, and thereby achieves each functional configuration unit of the display control apparatus 2000.

<Flow of Processing>

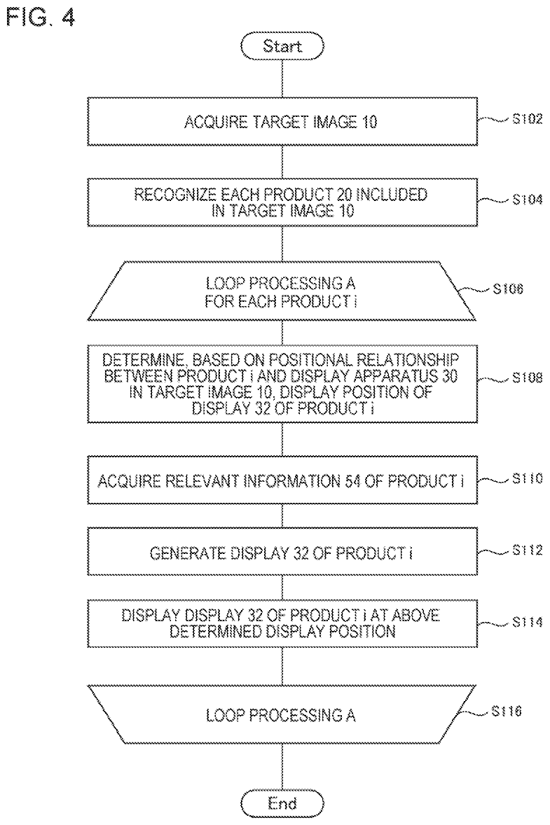

FIG. 4 is a flowchart illustrating a flow of processing executed by the display control apparatus 2000 according to the example embodiment 1. The first acquisition unit 2020 acquires a target image 10 (S102). The second acquisition unit 2040 recognizes each of products 20 included in the target image 10 (S104). S106 to S118 are loop processing A executed regarding each of the recognized products 20. In S106, the second acquisition unit 2040 determines whether the loop processing A has been already executed with all of the recognized products 20 as targets. When the loop processing A is executed with all of the recognized products 20 as targets, processing in FIG. 4 ends. When there is a product 20 that has not yet been targeted for the loop processing A, the display control apparatus 2000 selects one of the products 20. The product 20 selected herein is referred to as a product i. Then, the processing in FIG. 4 advances to S108.

The display position determination unit 2060 determines, based on a relative positional relationship in the target image 10 between the product i and a display apparatus 30, a display position on the display apparatus 30 at which a display 32 of the product i is displayed (S108). The second acquisition unit 2040 acquires relevant information 54 of the product i (S110). The display position determination unit 2060 generates the display 32 representing a content of the relevant information 54 of the product i (S112). The display position determination unit 2060 displays the display 32 of the product i at the determined display position (S114). Since S116 is a terminal of the loop processing A, the processing in FIG. 4 advances to S106.

Note that, a flow of processing executed by the display control apparatus 2000 is not limited to the processing illustrated in FIG. 4. For example, the processing of displaying the relevant information 54 of each of the products 20 on the display apparatus 30 (S116) may be collectively performed after determination of a display position and generation of a display 32 are performed regarding all of the products 20.

### Example of Utilization Environment

In order to ease understanding of the display control apparatus 2000, a utilization environment of the display control apparatus 2000 is more specifically exemplified. A utilization environment of the display control apparatus 2000 described herein is only an exemplification, and a utilization environment of the display control apparatus 2000 is not limited to the example given herein.

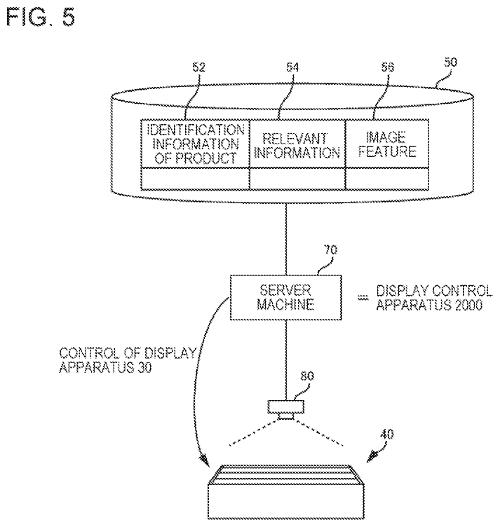

FIG. 5 is a diagram illustrating a utilization environment of the display control apparatus 2000. In FIG. 5, the display control apparatus 2000 is achieved by a server machine 70. Moreover, the relevant information storage apparatus 50 indicates an image feature 56 in addition to the identification information 52 and the relevant information 54. The image feature 56 is a piece of data representing a feature value of a product 20 on an image, and is utilized in order to recognize the product 20 included in a target image 10. However, the image feature 56 may be stored in a storage apparatus separate from the relevant information storage apparatus 50.

A camera 80 is a camera provided in a store, and captures an exhibition place 40. For example, the camera 80 regularly performs capture of the exhibition place 40, and transmits the generated target image 10 to the server machine 70. The camera 80 may be a still camera that generates a still image, or may be a video camera that generates a moving image. In the latter case, the target image 10 is one of video frames constituting a moving image.

The server machine 70 computes an image feature regarding each of the products 20 included in the received target image 10, performs matching between the image feature and the image feature 56 stored in the relevant information storage apparatus 50, and thereby recognizes each of the products 20. Further, the server machine 70 acquires the relevant information 54 regarding each of the products 20 from the relevant information storage apparatus 50.

The server machine 70 determines, regarding each of the products 20, a display position on the display apparatus 30 at which the relevant information 54 of the product 20 should be displayed. Then, the server machine 70 displays a display 32 generated regarding each of the products 20 at each of the determined display positions.

By receiving the target image 10 from the camera 80 provided in a store, and setting a display of the display apparatus 30 according to a content of the target image 10 in this way, a display of the display apparatus 30 is appropriately changed according to exhibition of the product 20 at the exhibition place 40 by a clerk, or movement of the exhibited product 20 by a clerk or a customer. Thus, a state in which appropriate information is displayed at an appropriate position of the display apparatus 30 can be easily maintained.

Note that, as described above, the utilization environment described by use of FIG. 5 is only an exemplification, and the display control apparatus 2000 is utilizable in various other environments. For example, a camera that generates a target image 10 may be a movable camera such as a camera provided in a portable terminal, instead of a camera fixedly placed in a store. In this case, for example, a clerk captures the exhibition place 40 with a camera provided in a portable terminal, and a generated target image 10 is transmitted to the server machine 70 from the portable terminal.

Moreover, the display control apparatus 2000 does not necessarily need to be achieved by a server machine, and may be achieved as, for example, the above-described portable terminal provided with a camera. In this case, display of the display apparatus 30 is controlled by a portable terminal that generates a target image 10.

<Regarding the display apparatus 30>

The display apparatus 30 is any display apparatus placeable in the exhibition place 40. For example, the display apparatus 30 has a long shape (e.g., a rectangular shape) in which a length in a longitudinal direction or a lateral direction is longer than the other. A display apparatus having such a shape is also referred to as a bar type display.

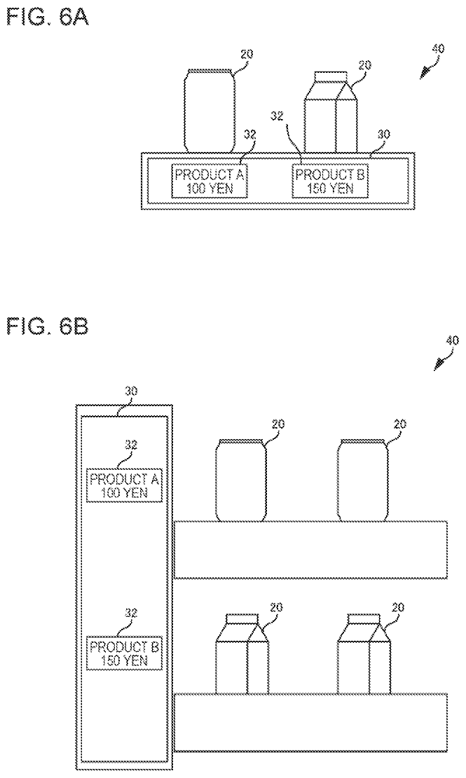

FIG. 6 is a diagram illustrating a scene in which a bar type display is utilized. In FIG. 6A, the display apparatus 30 being long in a lateral direction (horizontal direction) is utilized. The display apparatus 30 displays the display 32 for each of a plurality of the products 20 arranged in the exhibition place 40 in a horizontal direction.

On the other hand, in FIG. 6B, the display apparatus 30 being long in a longitudinal direction (vertical direction) is utilized. The display apparatus 30 displays the display 32 for each of a plurality of the products 20 arranged in the exhibition place 40 in a vertical direction.

<Acquisition of the target image 10: S102>

The first acquisition unit 2020 acquires the target image 10 (S102). A method by which the first acquisition unit 2020 acquires the target image 10 is any method. For example, the first acquisition unit 2020 acquires the target image 10 by receiving the target image 10 transmitted by the camera 80 that has generated the target image 10. Additionally, for example, the first acquisition unit 2020 may acquire the target image 10 by accessing a storage apparatus storing the target image 10. The storage apparatus may be provided either inside or outside the camera 80.

When acquiring the target image 10 by accessing the storage apparatus, the first acquisition unit 2020 recognizes, by any method, a fact that a new target image 10 that has not yet been acquired is stored in the storage apparatus, and acquires the target image 10. For example, the first acquisition unit 2020 recognizes presence of a new target image 10 by regularly accessing the storage apparatus, and acquires the target image 10. Additionally, for example, by receiving a notification representing that a new target image 10 is stored in the storage apparatus, the first acquisition unit 2020 may recognize presence of the new target image 10. For example, the notification is transmitted to the storage apparatus from the camera 80 storing the target image 10.

<Recognition of the product 20: S104>

The second acquisition unit 2040 recognizes each of the products 20 included in the target image 10 (S104). The recognition of the product 20 referred to herein means detecting an image region representing a product from the target image 10, and determining identification information (a JAN code or the like) of the product. Note that, an existing technique can be utilized for a technique of performing recognition of a product included in an image.

<Determination of a display position of the display 32: S108>

The display position determination unit 2060 determines, based on a relative positional relationship in the target image 10 between each of the products 20 and the display apparatus 30, a display position at which the display 32 of the product 20 is displayed in the display apparatus 30 (S108). Herein, a display position of the display 32 in the display apparatus 30 is represented by a coordinate of a criterion position (e.g., a central position) of the display 32 in a coordinate system (hereinafter, a display coordinate system) of the display apparatus 30. Accordingly, the display position determination unit 2060 determines a coordinate of a criterion position of the display 32 in the display coordinate system. For example, the display coordinate system is a coordinate system in which an upper left end of the display apparatus 30 in a plane view is an origin, a rightward direction is an x-direction, and a downward direction is a y-direction. Moreover, lengths of one pixel in the x-direction and the y-direction are unit lengths in the x-direction and the y-direction, respectively.

As described above, for example, the display apparatus 30 having a shape in which a length in a horizontal direction is longer than a length in a vertical direction (hereinafter, the display apparatus 30 being long in a horizontal direction), or the display apparatus 30 having a shape in which a length in a vertical direction is longer than a length in a horizontal direction (hereinafter, the display apparatus 30 being long in a vertical direction) is utilizable as the display apparatus 30. Hereinafter, regarding each of the two, a method of determining a display position of the display 32 is described.

<<A case where the display apparatus 30 is long in a horizontal direction>>

The display position determination unit 2060 determines, based on a relative positional relationship in the target image 10 between the product 20 and the display apparatus 30, an x-coordinate of a criterion position of the display 32 in the display coordinate system. Note that, in this case, a way of determining a y-coordinate of a criterion position of the display 32 is any way (e.g., the display 32 is displayed in a center of the display apparatus 30 regarding a vertical direction).

For example, in a real world, a criterion position of the display 32 is caused to correspond to a criterion position of the product 20 in a horizontal direction. To do so, the display position determination unit 2060 computes, based on a positional relationship on the target image 10 between the product 20 and the display apparatus 30, an x-coordinate on the display coordinate system, regarding a position on the display apparatus 30 corresponding to the criterion position of the product 20 in a horizontal direction. Then, the computed x-coordinate is determined to be an x-coordinate of the criterion position of the display 32.

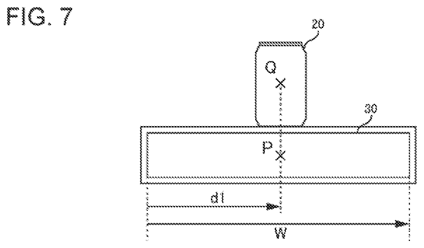

FIG. 7 is a first diagram illustrating a relative positional relationship on the target image 10 between the display 32 and the product 20. A position P is a criterion position of the display 32, and a position Q is a criterion position of the product 20. The criterion position P of the display 32 corresponds to the criterion position Q of the product 20 in a horizontal direction. In the target image 10, a distance in a horizontal direction from a left end of the display apparatus 30 to the criterion position Q of the product 20 is dl. Further, in the target image 10, a width of the display apparatus 30 is W.

Herein, it is assumed that, in the display coordinate system, a width of the display apparatus 30 is A (i.e., the number of pixels in a lateral direction is A). In this case, at a position on the display apparatus 30 corresponding to the criterion position Q of the product 20 in a horizontal direction, an x-coordinate on the display coordinate system becomes (d1/W)*A. Accordingly, the display position determination unit 2060 sets an x-coordinate of the criterion position P of the display 32 to (d1/W)*A. This allows a central position of the display 32 in a horizontal direction to correspond to a central position of the product 20 in a horizontal direction, in a real world.

Note that, for a criterion position of the display 32 and a criterion position of the product 20, a positional relationship thereof may be determined in advance, and the criterion positions do not necessarily need to correspond in a horizontal direction. For example, an offset in a horizontal direction of a criterion position of the display 32 and a criterion position of the product 20 is determined in advance. The display position determination unit 2060 determines an x-coordinate of a criterion position of the display 32 in such a way that a criterion position of the display 32 is shifted from a criterion position of the product 20 by the offset.

<<A case where the display apparatus 30 is long in a vertical direction>>

The display position determination unit 2060 determines, based on a relative positional relationship between the product 20 and the display apparatus 30, a y-coordinate of a criterion position of the display 32 in the display coordinate system. Note that, in this case, a way of determining an x-coordinate of a criterion position of the display 32 is any way (e.g., the display 32 is displayed in a center of the display apparatus 30 regarding a horizontal direction).

For example, in a real world, a criterion position of the display 32 in a vertical direction is caused to correspond to a criterion position of the product 20 in a vertical direction. To do so, the display position determination unit 2060 computes, based on a positional relationship on the target image 10 between the product 20 and the display apparatus 30, a y-coordinate on the display coordinate system, regarding a position on the display apparatus 30 corresponding to the criterion position of the product 20 in a vertical direction. Then, the computed y-coordinate is determined to be a y-coordinate of the criterion position of the display 32.

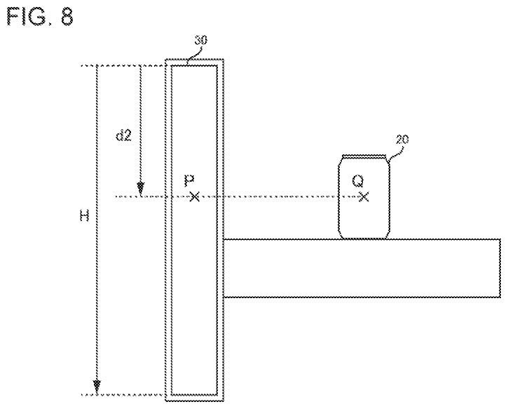

FIG. 8 is a second diagram illustrating a relative positional relationship on the target image 10 between the display 32 and the product 20. A position P is a criterion position of the display 32, and a position Q is a criterion position of the product 20. The criterion position P of the display 32 corresponds to the criterion position Q of the product 20 in a vertical direction. In the target image 10, a distance in a vertical direction from an upper end of the display apparatus 30 to a central position of the product 20 is d2. Further, in the target image 10, a height of the display apparatus 30 is H.

Herein, it is assumed that, in the display coordinate system, a height of the display apparatus 30 is B (i.e., the number of pixels in a vertical direction is B). In this case, at a position on the display apparatus 30 corresponding to the central position of the product 20 in a vertical direction, a y-coordinate on the display coordinate system becomes (d2/H)*B. Accordingly, the display position determination unit 2060 sets a y-coordinate of a display position P of the display 32 to (d/W)*B. This allows a central position of the display 32 in a vertical direction to correspond to a central position of the product 20 in a horizontal direction, in a real world.

Note that, for a criterion position of the display 32 and a criterion position of the product 20, a positional relationship thereof may be determined in advance, and the criterion positions do not necessarily need to correspond in a vertical direction. For example, regarding a criterion position of the display 32 and a criterion position of the product 20, an offset in a vertical direction is determined in advance. The display position determination unit 2060 determines a y-coordinate of a criterion position of the display 32 in such a way that a criterion position of the display 32 is shifted from a criterion position of the product 20 by the offset.

<A case where a plurality of the products 20 of the same kind are exhibited>

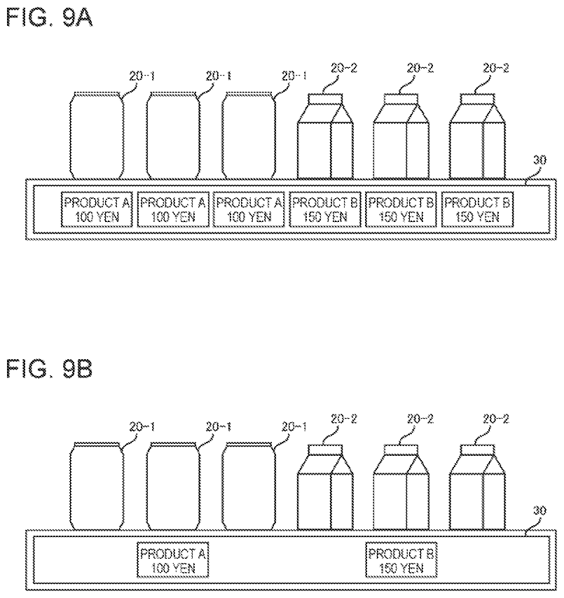

A plurality of the products 20 of the same kind may be exhibited in such a way as to be able to be seen from front. This can also be expressed as a “case where the number of faces of the product 20 is equal to or more than two”. FIG. 9 is a diagram illustrating a case where the number of faces of the product 20 is equal to or more than two. In FIG. 9, the number of faces of each of products A and B is three.

In such a case, for example, the display position determination unit 2060 displays each one display 32 regarding each of the products 20 of the same kind. For example, in FIG. 9A, the display 32 is displayed under each of the three products A that can be seen in a front view. The same also applies to the product B.

Additionally, for example, the display position determination unit 2060 may collectively display only one display 32 regarding the products 20 of the same kind. For example, in FIG. 9B, one display 32 is displayed at a center of the three products A that can be seen in a front view. The same also applies to the product B.

Herein, when displaying one display 32 regarding a plurality of the products 20 of the same kind in this way, for example, the display position determination unit 2060 collectively handles the plurality of the products 20 as one product 20. In this case, for example, a position such as a central position, a left-end position, or a right-end position of a region occupied by a plurality of the products 20 of the same kind is used as a criterion position of the product 20. Additionally, for example, a central position or the like of one of a plurality of the products 20 of the same kind may be handled as a criterion position of the product 20.

<A case where a plurality of the display apparatuses 30 are present>

There is a case where the target image 10 includes a plurality of the display apparatuses 30. For example, there is such a case that the exhibition place 40 is an exhibition shelf having a plurality of shelf boards, and the display apparatus 30 is placed on each of the shelf boards.

When there are a plurality of the display apparatuses 30 in the target image 10, the display position determination unit 2060 determines, regarding each of the products 20, the display apparatus 30 being caused to display the display 32 of the product 20. In other words, the display position determination unit 2060 performs association of the product 20 with the display apparatus 30. Then, the display position determination unit 2060 determines, regarding each of the products 20, a display position of the display 32 of the product 20, based on a relative positional relationship between the product 20 and the associated display apparatus 30. The display position of the display 32 of the product 20 is a position on the display apparatus 30 associated with the product 20.

Hereinafter, a method of associating the product 20 with the display apparatus 30 (a method of determining the display apparatus 30 being caused to display the display 32 of the product 20) is specifically described.

<<A case where the display apparatus 30 is long in a horizontal direction>>

<<<A case where a position in a vertical direction differs>>>

This is a case where the target image 10 includes a plurality of the display apparatuses 30 being long in a horizontal direction, and positions thereof in a vertical direction differ. Specifically, this is such a case that the exhibition place 40 is an exhibition shelf having a plurality of shelf boards, and the display apparatuses 30 are provided on two or more shelf boards. In this case, the display position determination unit 2060 associates the product 20 with the display apparatus 30, based on a relative positional relationship between the product 20 and the display apparatus 30 in a vertical direction, and a preliminary determined rule. A rule for associating the product 20 with the display apparatus 30 is stored in advance in a storage apparatus being accessible from the display position determination unit 2060.

For example, a rule “the display apparatus 30 is associated with each of the products 20 exhibited on a shelf board on which the display apparatus 30 is placed” is determined. In this rule, on the display apparatus 30, the display 32 of each of the products 20 positioned immediately on the display apparatus 30 is displayed.

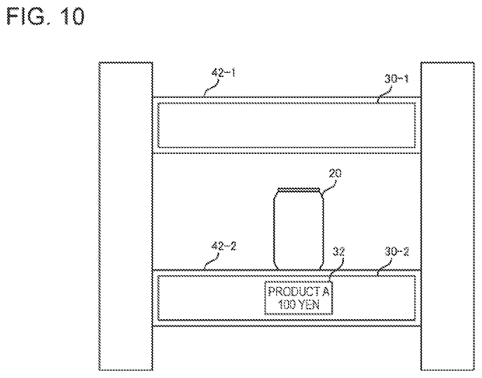

FIG. 10 is a diagram illustrating a case where the display 32 of the product 20 is displayed on the display apparatus 30 provided on a shelf board 42 on which the product 20 is exhibited. In this example, display apparatuses 30-1 and 30-2 are provided on two shelf boards 42-1 and 42-2, respectively. Moreover, the product 20 is exhibited on the shelf board 42-2.

Herein, by the rule described above, the product 20 is associated with the display apparatus 30-2 placed on the shelf board 42-2 on which the product 20 is exhibited. Thus, the display 32 is displayed on the display apparatus 30-2.

A specific method of performing association of the product 20 with the display apparatus 30 in accordance with the rule is any method. For example, the display position determination unit 2060 determines, regarding each of the display apparatuses 30 included in the target image 10, which shelf board the display apparatuses 30 are each provided on (e.g., what position a shelf board is at from top in the target image 10). Similarly, the display position determination unit 2060 determines, regarding each of the products 20 included in the target image 10, which shelf board the products 20 are each exhibited on (e.g., what position a shelf board on which the product 20 is exhibited is at from top in the target image 10). Then, the display position determination unit 2060 associates the product 20 and the display apparatus 30 that are positioned on the same shelf board.

As another rule, for example, a rule “the display apparatus 30 is associated with each of the products 20 exhibited on a shelf board being one shelf board lower than a shelf board on which the display apparatus 30 is placed” is determined. In this rule, on the display apparatus 30, the display 32 of each of the products 20 positioned immediately under the display apparatus 30 is displayed.

A specific method of performing association of the product 20 with the display apparatus 30 in accordance with the rule is any method. For example, by the above-described method, the display position determination unit 2060 determines, regarding each of the display apparatuses 30 included in the target image 10, which shelf board the display apparatuses 30 are each positioned. Similarly, the display position determination unit 2060 determines, regarding each of the products 20, which shelf board the products 20 are each positioned. Then, the display position determination unit 2060 associates the display apparatus 30 with each of the products 20 exhibited on a shelf board being one shelf board lower than a shelf board on which the display apparatus 30 is provided.

<<<A case where a position in a horizontal direction differs>>>

This is a case where the target image 10 includes a plurality of the display apparatuses 30 being long in a horizontal direction, and positions thereof in a horizontal direction differ.

For example, this is such a case that a plurality of the display apparatuses 30 are arranged and placed in a horizontal direction in one shelf board 42. In this case, the display position determination unit 2060 associates the product 20 with the display apparatus 30, based on a positional relationship between the product 20 and the display apparatus 30 in a horizontal direction, and a preliminary determined rule. For example, a rule “among a plurality of the display apparatuses 30, the display apparatus 30 for which the product 20 is positioned between a left end and a right end of the display apparatus 30 is associated with the product 20” is determined as a preliminary rule.

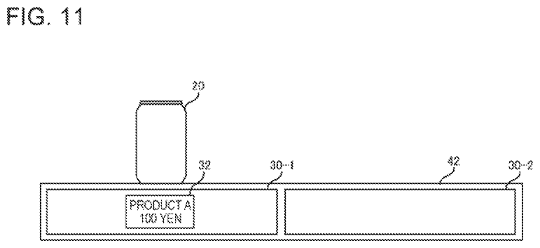

FIG. 11 is a diagram illustrating a case where a plurality of the display apparatuses 30 are provided on one shelf board 42. In this example, display apparatuses 30-1 and 30-2 are provided on the shelf board 42 on which the product 20 is exhibited.

Herein, the product 20 is positioned between a left end and a right end of the display apparatus 30-1. On the other hand, the product 20 is not positioned between a left end and a right end of the display apparatus 30-2. Accordingly, the display position determination unit 2060 associates the product 20 with the display apparatus 30-1. Thus, the display 32 is displayed on the display apparatus 30-1.

<<A case where the display apparatus 30 is long in a vertical direction>>

<<<A case where a position in a horizontal direction differs>>>

This is a case where the target image 10 includes a plurality of the display apparatuses 30 being long in a vertical direction, and positions thereof in a horizontal direction differ. Specifically, this is such a case that a plurality of side walls (partitions or columns) are present in the exhibition place 40, and the display apparatuses 30 is placed in each of the side walls.

In this case, the display position determination unit 2060 associates the product 20 with the display apparatus 30, based on a positional relationship between the product 20 and the display apparatus 30 in a horizontal direction, and a preliminary determined rule. For example, a rule “the product 20 is associated with the display apparatus 30 being positioned on a left side of the product 20 and being nearest to the product 20 regarding a horizontal direction” is determined. In this case, for example, the display position determination unit 2060 determines, regarding each of the display apparatuses 30 and each of the products 20 included in the target image 10, positions thereof in a horizontal direction (e.g., central positions). Then, the display position determination unit 2060 associates the product 20 with the display apparatus 30 being nearest in distance to the product 20 in a horizontal direction among the display apparatuses 30 positioned closer to a left side than the product 20. Note that, “left side” may be “right side” in the above-described rule.

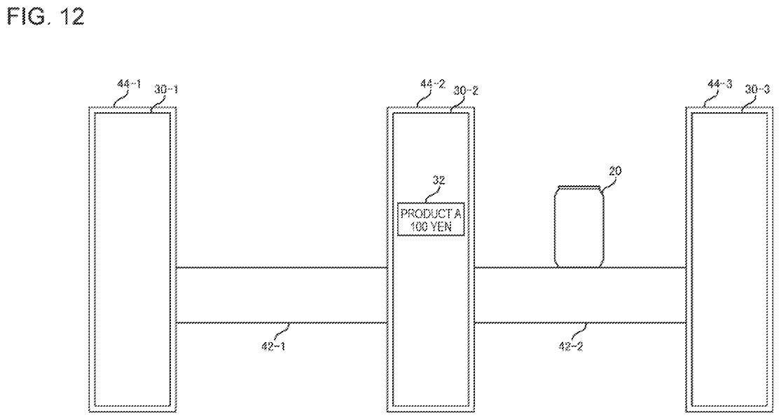

FIG. 12 is a diagram illustrating a case where a plurality of the display apparatuses 30 being long in a vertical direction are provided at positions differing from each other in a horizontal direction. FIG. 12 includes shelf boards 42-1 and 42-2, and side walls 44-1 to 44-3. The side walls 44-1 to 44-3 are provided with display apparatuses 30-1 to 30-3, respectively. The product 20 is exhibited on the shelf board 42-2.

Herein, it is assumed that the display apparatus 30 is associated with the product 20 under the above-described rule “the product 20 is associated with the display apparatus 30 being positioned on a left side of the product 20 and being nearest to the product 20 regarding a horizontal direction”. In this point, in FIG. 12, the display apparatus 30 being positioned on a left side of the product 20 and also being nearest in distance to the product 20 in a horizontal direction is the display apparatus 30-2. Accordingly, the display position determination unit 2060 associates the product 20 with the display apparatus 30-2. Thus, the display 32 is displayed on the display apparatus 30-2.

<<<A case where a plurality of the display apparatuses 30 are present in a vertical direction>>>

This is a case where the target image 10 includes a plurality of the display apparatuses 30 being long in a vertical direction, and positions thereof in a vertical direction differ. Specifically, this is such a case that a plurality of the display apparatuses 30 are arranged and placed in a vertical direction in one side wall 44 of an exhibition shelf.

In this case, the display position determination unit 2060 performs association of the product 20 with the display apparatus 30, based on a positional relationship between the product 20 and the display apparatus 30 in a vertical direction, and a preliminary determined rule. For example, a rule “among a plurality of the display apparatuses 30, the display apparatus 30 for which the product 20 is positioned between an upper end and a lower end of the display apparatus 30 is associated with the product 20” is determined as a preliminary rule.

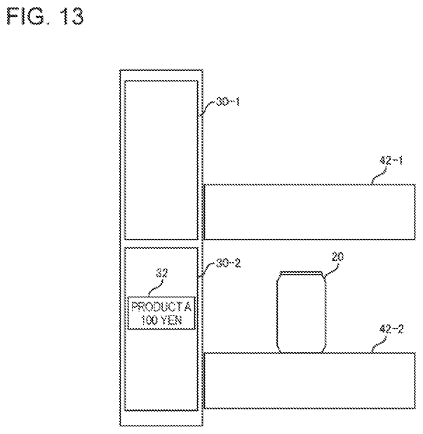

FIG. 13 is a diagram illustrating a case where a plurality of the display apparatuses 30 are provided on one side wall 44. The side wall 44 is provided with two display apparatuses 30 being display apparatuses 30-1 and 30-2. Moreover, shelf boards 42-1 and 42-2 are provided, and the product 20 is exhibited on the shelf board 42-2.

Herein, the product 20 is not positioned between an upper end and a lower end of the display apparatus 30-1, but is positioned between an upper end and a lower end of the display apparatus 30-2. Accordingly, the display position determination unit 2060 associates the product 20 with the display apparatus 30-2. Thus, the display 32 is displayed on the display apparatus 30-2.

<Acquisition of the relevant information 54: S110>

The second acquisition unit 2040 acquires the relevant information 54 of the product 20 (S108). Specifically, the second acquisition unit 2040 acquires, from the relevant information storage apparatus 50, the relevant information 54 being associated with the identification information 52 of the product 20.

The relevant information 54 is information relating to the product 20, and is displayed on the display apparatus 30. For example, the relevant information 54 includes a name or a price of the product 20. For example, in FIG. 1, a product name and a price are displayed on the display apparatus 30 regarding each of the products 20-1 and 20-2.

A data format of the relevant information 54 indicating a name or a price of the product 20 is any data format. For example, the relevant information 54 indicates a name or a price of the product 20 by text data. Additionally, for example, the relevant information 54 may indicate a name or a price of the product 20 by image data.

The relevant information 54 may be information representing an advertisement relating to the product 20. In this case, the advertisement of the product 20 is displayed on the display apparatus 30. Herein, an advertisement relating to the product 20 may be an advertisement relating to the product 20 itself, or may be another advertisement. In the latter case, an advertisement relating to the product 20 is, for example, an advertisement of another product belonging to the same series as the product 20, an advertisement relating to a manufacturer of the product 20, or the like.

In this case as well, a data format of the relevant information 54 is any data format. For example, the relevant information 54 indicates an advertisement of the product 20 by text data. Additionally, for example, the relevant information 54 indicates an advertisement of the product 20 by one image or a plurality of time-series images (e.g., a moving image file). In the latter case, the time-series images representing an advertisement of the product 20 are sequentially displayed on the display apparatus 30.

<Generation of the display 32: S112>

The display control unit 2080 generates, by use of the relevant information 54 acquired regarding the product 20, the display 32 regarding the product 20 (S112). For example, the display control unit 2080 generates the display 32 by applying a content of the acquired relevant information 54 to a template prepared in advance. The template is stored in advance in a storage apparatus being accessible from the display control unit 2080.

A template is information determining a display form of information included in the relevant information 54. For example, when the relevant information 54 represents a name and a price of a product, a placement, a size ratio, and the like of each of the name and the price of the product are determined in the template.

A specific achievement method of a template is any method. For example, a template is defined as an HTML element. When a name and a price of a product are utilized as the relevant information 54, an HTML element in which a character string or an image representing the name and the price of the product can be embedded is prepared as, for example a template.

Namely, a part in which the name of the product is embedded, and a part in which the price of the product is embedded are each prepared in the HTML element.

The display control unit 2080 embeds each of a name and a price of the product 20 indicated by the relevant information 54 into a relevant part of an HTML element prepared as a template. The HTML element in which the name and the price of the product 20 are embedded is rendered by a rendering engine of HTML, and, thereby, the display 32 is generated.

The same also applies to a case where an advertisement of the product 20 is utilized as the relevant information 54. Namely, an HTML element in which a text or an image representing an advertisement of the product 20 can be embedded is prepared as a template, the display control unit 2080 embeds a content of the relevant information 54 into the HTML element, and, thereby, the display 32 is generated.

Herein, when a particular advertisement for the product 20 does not exist, a separately prepared advertisement (hereinafter, a default advertisement) may be utilized. The default advertisement is stored in a storage apparatus being accessible from the second acquisition unit 2040. For example, when the relevant information 54 being related to the product 20 does not exist, or when the relevant information 54 being related to the product 20 indicates that there is not an advertisement relating to the product 20, the second acquisition unit 2040 acquires the default advertisement described above, and generates the display 32 with the default advertisement. For example, the default advertisement is an advertisement relating to a store, such as an advertisement of a discount, point return, or the like common to all products in a store, or an advertisement relevant to a sponsor of a store.

Note that, a template does not necessarily need to be defined as an HTML element, and may be defined by any method of the other method.

Moreover, the display control unit 2080 does not have to utilize a template for generation of the display 32. For example, it is assumed that the relevant information 54 indicates information relating to the product 20 by an image. In this case, the display control unit 2080 may utilize the relevant information 54 as the display 32 without modification.

Additionally, for example, the relevant information 54 may include not only a content of information relating to the product 20, but also a display form of the content. Specifically, including, as the relevant information 54, an HTML element in which a name and a price of the product 20 are embedded, or the like can be conceived. In this way, a display form of information relating to the product 20 can be determined for each of the products 20 by including information relating to a display form in the relevant information 54.

<<Regarding a size of the display 32>>

Herein, a size of the display 32 may be fixedly determined, or may be determined according to an exhibition status of the product 20. In the latter case, for example, the display control unit 2080 determines, based on a size of a region occupied by each of the products 20 in the exhibition place 40, a size of the display 32 of the product 20.

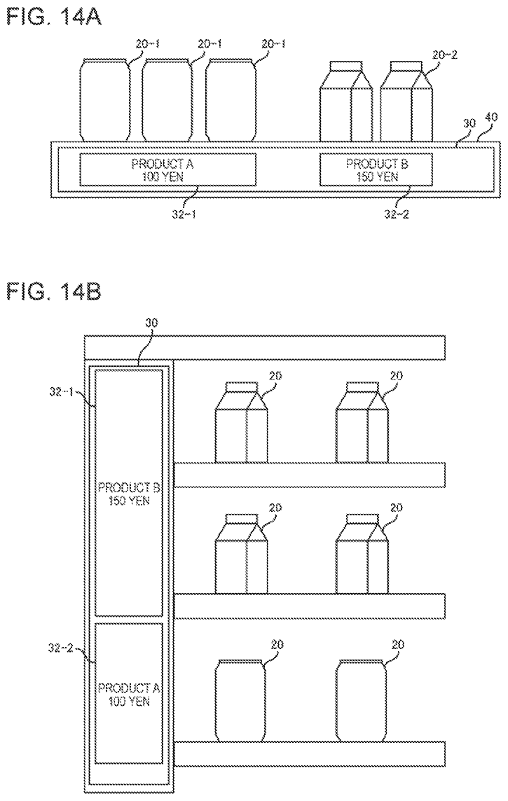

FIG. 14 is a diagram illustrating a case where a size of the display apparatus 30 is determined according to an exhibition status of the product 20. In FIG. 14A, the display control unit 2080 sets a width of the display 32 to the same width as a width of a region occupied by the product 20 of the same kind. In FIG. 14B, the display control unit 2080 sets a height of the display 32 to the same height as a height of a region (stage) occupied by the product 20 of the same kind.

Herein, a plurality of the above-described templates may be prepared according to a size of the display 32. In this case, when generating the display 32, the display control unit 2080 utilizes a template corresponding to a size of the display 32 determined according to an exhibition status of the product 20. This generates the display 32 in an appropriate display form according to a size. For example, the display 32 in which a product name and a price are alternately displayed is generated in a template corresponding to a case where a size of the display 32 is comparatively small (e.g., a case where a width or a height is less than a predetermined value), and the display 32 in which both a product name and a price are displayed at once is generated in a template corresponding to a case where a size of the display 32 is comparatively large (e.g., a case where a width or a height is equal to or more than a predetermined value). Additionally, for example, the display 32 including only a product name and a price is generated in a template corresponding to a case where a size of the display 32 is comparatively small, and the display 32 including another piece of information (e.g., an advertisement or the like) in addition to a product name and a price is generated in a template corresponding to a case where a size of the display 32 is comparatively large.

<Display of the display 32: S114>

The display control unit 2080 displays the display 32 of each of the products 20 at a display position on the display apparatus 30 determined regarding the product 20 (S114). Herein, in order to actually control the display apparatus 30 detected from the target image 10 by an image analysis, the display control unit 2080 needs to be able to determine the display apparatus 30 to be controlled, from among one or more display apparatuses 30 in a real world. Namely, the display control unit 2080 needs to determine identification information of the display apparatus 30. For example, it is assumed that the display control unit 2080 transmits control information (e.g., information including the display 32 and a display position thereof) to the display apparatus 30, and thereby causes the display apparatus 30 to display the display 32. In this case, the display control unit 2080 needs to recognize an address (a MAC address or the like) of a destination as identification information of the display apparatus 30.

Regarding the display apparatus 30 detected from the target image 10, methods of determining identification information thereof are varied. For example, information (hereinafter, display placement information) indicating identification information and a placement position of each of the display apparatuses 30 is stored in a storage apparatus in advance, and the identification information of each of the display apparatuses 30 is determined by utilizing the information.

As a more specific example, it is assumed that, for each exhibition shelf, a camera that captures the exhibition shelf is prepared. In this case, in association with identification information of a camera, display placement information of each of the display apparatuses 30 placed on an exhibition shelf to be captured by the camera is stored in a storage apparatus in advance. The display control unit 2080 determines identification information of a camera generating the target image 10 acquired by the first acquisition unit 2020, and acquires display placement information being associated with the identification information. The display control unit 2080 determines display placement information being associated with each of the display apparatuses 30 included in the target image 10, by comparing a position of each of the display apparatuses 30 within the target image 10 with a placement position of the display apparatus 30 indicated by each piece of the acquired display placement information. Thereby, identification information of each of the display apparatuses 30 included in the target image 10 is determined.

Note that, a camera may be configured in such a way that a field angle thereof can be changed (e.g., a PTZ camera). In this case, the display control unit 2080 can recognize a capture range (i.e., which part of an exhibition shelf is included in the target image 10) of the camera at a timing when the target image 10 is generated, by using the target image 10, and a camera parameter (a pan value, a tilt value, a zoom value, and the like) when the target image 10 is captured. The display control unit 2080 determines identification information of each of the display apparatuses 30 included in the target image 10, by utilizing display placement information and a capture range of a camera determined by utilizing a camera parameter.

Additionally, for example, each of the display apparatuses 30 may be provided with a function of displaying own identification information. In this case, the display control apparatus 2000 acquires the target image 10 capturing each of the display apparatuses 30 in a state where identification information is displayed, performs an image analysis of the target image 10, and thereby determines the identification information displayed on each of the display apparatuses 30. Thereby, the display control apparatus 2000 can recognize identification information of each of the display apparatuses 30 included in the target image 10. Note that, for example, a technique disclosed in Patent Document 2 can be utilized for a technique of “causing a display apparatus to display identification information, analyzing an image including the display apparatus, and thereby recognizing identification information of the display apparatus”.

Some or all of the above-described example embodiments can also be described as, but are not limited to, the following supplementary notes.

1. A display control apparatus including:

a first acquisition unit that acquires a target image, the target image including a display apparatus provided at an exhibition place of a product, and a product exhibited at the exhibition place;

a second acquisition unit that recognizes a product included in the target image, and acquires relevant information being information relevant to the product;

a display position determination unit that determines, based on a relative positional relationship within the target image between the product and the display apparatus, a display position at which a relevant display representing relevant information of the product is displayed in the display apparatus; and

a display control unit that displays the relevant display of the product at the determined display position on the display apparatus.

2. The display control apparatus according to supplementary note 1, wherein

the target image includes a plurality of the display apparatuses,

the display position determination unit determines, based on a positional relationship within the target image between the product and each of the display apparatuses, the display apparatus being caused to display the relevant display of the product, and a display position of the relevant display on the display apparatus, and

the display control unit displays the relevant display of the product at the determined display position of the determined display apparatus.

3. The display control apparatus according to supplementary note 2, wherein a plurality of the display apparatuses are provided on one shelf board or one side wall.

4. The display control apparatus according to any one of supplementary notes 1 to 3, wherein

the relevant information includes a name and a price of the product, or includes an advertisement relating to the product.

5. The display control apparatus according to any one of supplementary notes 1 to 4, wherein

the display control unit determines a size of the relevant display of the product, based on a size of a region occupied by the product in the target image.

6. The display control apparatus according to any one of supplementary notes 1 to 5, wherein

the display control unit acquires a template determining a display form of the relevant display, and generates the relevant display representing the relevant information by use of the relevant information and the template.

7. The display control apparatus according to supplementary note 6, wherein

a plurality of the templates according to a size of a region occupied by the product in the target image are prepared, and

the display control unit generates the relevant display of the product by use of a template corresponding to a size of a region occupied by the product in the target image.

8. A control method executed by a computer, including:

a first acquisition step of acquiring a target image, the target image including a display apparatus provided at an exhibition place of a product, and a product exhibited at the exhibition place;

a second acquisition step of recognizing a product included in the target image, and acquiring relevant information being information relevant to the product;

a display position determination step of determining, based on a relative positional relationship within the target image between the product and the display apparatus, a display position at which a relevant display representing relevant information of the product is displayed in the display apparatus; and

a display control step of displaying the relevant display of the product at the display position on the display apparatus.

9. The control method according to supplementary note 8, wherein the target image includes a plurality of the display apparatuses, the control method further including:

in the display position determination step, determining, based on a positional relationship within the target image between the product and each of the display apparatuses, the display apparatus being caused to display the relevant display of the product, and a display position of the relevant display on the display apparatus; and

in the display control step, displaying the relevant display of the product at the determined display position of the determined display apparatus.

10. The control method according to supplementary note 9, wherein

a plurality of the display apparatuses are provided on one shelf board or one side wall.

11. The control method according to any one of supplementary notes 8 to 10, wherein

the relevant information includes a name and a price of the product, or includes an advertisement relating to the product.

12. The control method according to any one of supplementary notes 8 to 11, further including,

in the display control step, determining a size of the relevant display of the product, based on a size of a region occupied by the product in the target image.

13. The control method according to any one of supplementary notes 8 to 12, further including,

in the display control step, acquiring a template determining a display form of the relevant display, and generating the relevant display representing the relevant information by use of the relevant information and the template.

14. The control method according to supplementary note 13, wherein

a plurality of the templates according to a size of a region occupied by the product in the target image are prepared,

the control method further including,

in the display control step, generating the relevant display of the product by use of a template corresponding to a size of a region occupied by the product in the target image.

15. A program causing a computer to execute the control method according to any one of supplementary notes 8 to 14.

An example of a further reference embodiment is set forth below.

16. A control method executed by a computer achieving a display control apparatus, including,

by the display control apparatus, acquiring a target image, the target image including a display apparatus provided at an exhibition place of a product, and a product exhibited at the exhibition place, the control method further including:

by the display control apparatus, recognizing a product included in the target image, and acquiring relevant information being information relevant to the product;

determining, based on a relative positional relationship within the target image between the product and the display apparatus, a display position at which a relevant display representing relevant information of the product is displayed in the display apparatus; and

displaying the relevant display of the product at the display position on the display apparatus.

17. The control method according to supplementary note 16, wherein the target image includes a plurality of the display apparatuses, the control method further including:

by the display control apparatus, determining, based on a positional relationship within the target image between the product and each of the display apparatuses, the display apparatus being caused to display the relevant display of the product, and a display position of the relevant display on the display apparatus; and

displaying the relevant display of the product at the determined display position of the determined display apparatus.

18. The control method according to supplementary note 17, wherein a plurality of the display apparatuses are provided on one shelf board or one side wall.

19. The control method according to any one of supplementary notes 16 to 18, wherein

the relevant information includes a name and a price of the product, or includes an advertisement relating to the product.

20. The control method according to any one of supplementary notes 16 to 19, further including,

by the display control apparatus, determining a size of the relevant display of the product, based on a size of a region occupied by the product in the target image, and displaying the relevant display of the determined size.

21. The control method according to any one of supplementary notes 16 to 20, further including,

by the display control apparatus, acquiring a template determining a display form of the relevant display, generating the relevant display representing the relevant information by use of the relevant information and the template, and displaying the generated relevant display.

22. The control method according to supplementary note 21, wherein a plurality of the templates according to a size of a region occupied by the product in the target image are prepared,

the control method further including, by the display control apparatus,

generating the relevant display of the product by use of a template corresponding to a size of a region occupied by the product in the target image, and displaying the generated relevant display.

23. A program causing a computer to execute a procedure of acquiring a target image,

the target image including a display apparatus provided at an exhibition place of a product, and a product exhibited at the exhibition place, and

causing a computer to execute a procedure of recognizing a product included in the target image, and acquiring relevant information being information relevant to the product,

a procedure of determining, based on a relative positional relationship within the target image between the product and the display apparatus, a display position at which a relevant display representing relevant information of the product is displayed in the display apparatus, and

a procedure of displaying the relevant display of the product at the display position on the display apparatus.

24. The program according to supplementary note 23, wherein the target image includes a plurality of the display apparatuses,

the program causing a computer to execute a procedure of determining, based on a positional relationship within the target image between the product and each of the display apparatuses, the display apparatus being caused to display the relevant display of the product, and a display position of the relevant display on the display apparatus, and

a procedure of displaying the relevant display of the product at the determined display position of the determined display apparatus.

25. The program according to supplementary note 24, wherein a plurality of the display apparatuses are provided on one shelf board or one side wall.

26. The program according to any one of supplementary notes 23 to 25, wherein the relevant information includes a name and a price of the product, or includes an advertisement relating to the product.

27. The program according to any one of supplementary notes 23 to 26, causing a computer to execute

a procedure of determining a size of the relevant display of the product, based on a size of a region occupied by the product in the target image, and displaying the relevant display of the determined size.

28. The program according to any one of supplementary notes 23 to 27, causing a computer to execute

a procedure of acquiring a template determining a display form of the relevant display, generating the relevant display representing the relevant information by use of the relevant information and the template, and displaying the generated relevant display.

29. The program according to supplementary note 28, wherein a plurality of the templates according to a size of a region occupied by the product in the target image are prepared,

the program causing a computer to execute a procedure of generating the relevant display of the product by use of a template corresponding to a size of a region occupied by the product in the target image, and displaying the generated relevant display.

This application is based upon and claims the benefit of priority from Japanese patent application No. 2019-223559, filed on Dec. 11, 2019, the disclosure of which is incorporated herein in its entirety by reference.

### REFERENCE SIGNS LIST

10 Target image

20 Product

30 Display apparatus

32 Display

40 Exhibition place

42 Shelf board

44 Side wall

50 Relevant information storage apparatus

52 Identification information

54 Relevant information

56 Image feature

70 Server machine

80 Camera

1000 Computer

1020 Bus

1040 Processor

1060 Memory

1080 Storage device

1100 Input/output interface

1120 Network interface

2000 Display control apparatus

2020 First acquisition unit

2040 Second acquisition unit

2060 Display position determination unit

2080 Display control unit

What is claimed is:

1. A display control apparatus comprising:
at least one memory configured to store instructions; and
at least one processor configured to execute the instructions to:
acquire a target image, the target image including a display apparatus provided at an exhibition place of a product, and a product exhibited at the exhibition place;
recognize a product included in the target image, and acquire relevant information being information relevant to the product;
determine, based on a relative positional relationship within the target image between the product and the display apparatus, a display position at which a relevant display representing relevant information of the product is displayed in the display apparatus; and
display the relevant display of the product at the determined display position on the display apparatus.

2. The display control apparatus according to claim 1, wherein the target image includes a plurality of the display apparatuses, the at least one processor configured to further execute the instructions to:
determine, based on a positional relationship within the target image between the product and each of the display apparatuses, the display apparatus being caused to display the relevant display of the product, and a display position of the relevant display on the display apparatus; and
display the relevant display of the product at the determined display position of the determined display apparatus.

3. The display control apparatus according to claim 2, wherein
a plurality of the display apparatuses are provided on one shelf board or one side wall.

4. The display control apparatus according to claim 1, wherein
the relevant information includes a name and a price of the product, or includes an advertisement relating to the product.

5. The display control apparatus according to claim 1, wherein
the at least one processor configured to further execute the instructions to determine a size of the relevant display of the product, based on a size of a region occupied by the product in the target image.

6. The display control apparatus according to claim 1, wherein
the at least one processor configured to further execute the instructions to acquire a template determining a display form of the relevant display, and generate the relevant display representing the relevant information by use of the relevant information and the template.

7. The display control apparatus according to claim 6, wherein
a plurality of the templates according to a size of a region occupied by the product in the target image are prepared, and
the at least one processor configured to further execute the instructions to generate the relevant display of the product by use of a template corresponding to a size of a region occupied by the product in the target image.

8. A control method executed by a computer achieving a display control apparatus, comprising,
by the display control apparatus, acquiring a target image,
the target image including a display apparatus provided at an exhibition place of a product, and a product exhibited at the exhibition place,
the control method further comprising:
by the display control apparatus, recognizing a product included in the target image, and acquiring relevant information being information relevant to the product;
determining, based on a relative positional relationship within the target image between the product and the display apparatus, a display position at which a relevant display representing relevant information of the product is displayed in the display apparatus; and
displaying the relevant display of the product at the display position on the display apparatus.

9. The control method according to claim 8, wherein the target image includes a plurality of the display apparatuses, the control method further comprising:
by the display control apparatus, determining, based on a positional relationship within the target image between the product and each of the display apparatuses, the display apparatus being caused to display the relevant display of the product, and a display position of the relevant display on the display apparatus; and
displaying the relevant display of the product at the determined display position of the determined display apparatus.

10. The control method according to claim 9, wherein a plurality of the display apparatuses are provided on one shelf board or one side wall.

11. The control method according to claim 8, wherein the relevant information includes a name and a price of the product, or includes an advertisement relating to the product.

12. The control method according to claim 8, further comprising,
by the display control apparatus, determining a size of the relevant display of the product, based on a size of a region occupied by the product in the target image, and displaying the relevant display of the determined size.

13. The control method according to claim 8, further comprising,
by the display control apparatus,
acquiring a template determining a display form of the relevant display, generating the relevant display representing the relevant information by use of the relevant information and the template, and displaying the generated relevant display.

14. The control method according to claim 13, wherein
a plurality of the templates according to a size of a region occupied by the product in the target image are prepared,
the control method further comprising, by the display control apparatus,
generating the relevant display of the product by use of a template corresponding to a size of a region occupied by the product in the target image, and displaying the generated relevant display.

15. A non-transitory computer-readable storage medium storing a program causing a computer to execute
a procedure of acquiring a target image,
the target image including a display apparatus provided at an exhibition place of a product, and a product exhibited at the exhibition place, and
causing a computer to execute
a procedure of recognizing a product included in the target image, and acquiring relevant information being information relevant to the product,
a procedure of determining, based on a relative positional relationship within the target image between the product and the display apparatus, a display position at which a relevant display representing relevant information of the product is displayed in the display apparatus, and
a procedure of displaying the relevant display of the product at the display position on the display apparatus.

16. The non-transitory computer-readable storage medium according to claim 15, wherein
the target image includes a plurality of the display apparatuses,
the program causing a computer to execute
a procedure of determining, based on a positional relationship within the target image between the product and each of the display apparatuses, the display apparatus being caused to display the relevant display of the product, and a display position of the relevant display on the display apparatus, and
a procedure of displaying the relevant display of the product at the determined display position of the determined display apparatus.

17. The non-transitory computer-readable storage medium according to claim 16, wherein
a plurality of the display apparatuses are provided on one shelf board or one side wall.

18. The non-transitory computer-readable storage medium according to claim 15, wherein
the relevant information includes a name and a price of the product, or includes an advertisement relating to the product.

19. The non-transitory computer-readable storage medium according to claim 15, wherein the program causes a computer to execute
a procedure of determining a size of the relevant display of the product, based on a size of a region occupied by the product in the target image, and displaying the relevant display of the determined size.

20. The non-transitory computer-readable storage medium according to claim 15, wherein the program causes a computer to execute
a procedure of acquiring a template determining a display form of the relevant display, generating the relevant display representing the relevant information by use of the relevant information and the template, and displaying the generated relevant display.

21. (canceled)
